(19) United States
(12) Patent Application Publication
(10) Pub. No.: US 2009/0323810 A1
(43) Pub. Date: Dec. 31, 2009

(54) VIDEO ENCODING APPARATUSES AND METHODS WITH DECOUPLED DATA DEPENDENCY

(75) Inventors: Wen-Jun Liu, Hsinchu County (TW); Shih-Chang Hu, Hsin-Chu City (TW); Shien-Tai Pan, Laguna Niguel, CA (US)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 12/146,683

(22) Filed: Jun. 26, 2008

(51) Int. Cl. H04N 7/32; H04N 7/26

(52) U.S. Cl. 375/240.16; 375/240.12; 375/E07.125

(57) ABSTRACT

The invention provides an apparatus for video encoding with decoupled data dependency. In one embodiment, the apparatus comprises a buffer, a hardware circuit, and a parameter determination module. The hardware circuit, coupled to the buffer, generates and stores data during performing motion estimation on a current frame and encoding a plurality of macroblocks of the current frame in the buffer. The parameter determination module, coupled to the hardware circuit and the buffer, retrieves the stored data from the buffer, generates at least one reference parameter for a plurality of macroblocks of a future frame according to the retrieved data, and updates data of the buffer with the generated reference parameters after receiving a triggering signal indicating start of data preparation for the future frame from the hardware circuit.

### BACKGROUND OF THE INVENTION

1. Field of the Invention

The invention relates to video signal processing, and more particularly to video encoding apparatus and methods with decoupled data dependency.

2. Description of the Related Art

An electronic apparatus with a video camera, such as a feature mobile phone or a surveillance application, is increasingly used to capture motion pictures to obtain real-time video data. A video camera pixel sensor first captures successive pictures to obtain a series of raw video frames. To reduce raw video frame data amount, the raw video frames must be compressed to obtain specifically formatted encoded video data, such as MPEG-2 or MPEG-4. The compression process is referred to as video encoding. The video data generated from video encoding comprises a series of compressed video frames. Each compressed video frame typically comprises a plurality of macroblocks made up of a certain number of pixels, such as 16×16 or 8×8 pixels. Each of the macroblocks is encoded sequentially during the compression process.

Video encoding efficiency greatly affects video camera performance. A video encoding process comprises a series of component processes, such as motion estimation, motion compensation, quantization, discrete cosine transformation (DCT), and variable length encoding (VLE). Accordingly, a video encoding apparatus comprises multiple component modules performing some of the component procedures of the video encoding process. When a video encoding apparatus encodes video frames, data processing speeds of the component modules of the video encoding apparatus must synchronize with each other to generate a maximum number of encoded frames during a limited time period. Otherwise, the speed for generating encoded frames dramatically decreases, and performance of the video encoding apparatus degrades. A method for synchronizing component procedures of video encoding is therefore required.

### BRIEF SUMMARY OF THE INVENTION

The invention provides a method for video encoding with decoupled data dependency. First, at least one reference parameter for a macroblock of the current frame is acquired from a buffer, wherein the reference parameter is determined according to data of the corresponding macroblock of a previous frame. The macroblock of the current frame is then encoded according at least to the determined reference parameter to generate an output bitstream.

The invention provides an apparatus for video encoding with decoupled data dependency. In one embodiment, the apparatus comprises a buffer, a hardware circuit, and a parameter determination module. The hardware circuit, coupled to the buffer, generates and stores data during performing motion estimation on a current frame and encoding a plurality of macroblocks of the current frame in the buffer. After receiving a triggering signal indicating start of data preparation for the future frame from the hardware circuit the parameter determination module, coupled to the hardware circuit and the buffer, retrieves the stored data from the buffer, generates at least one reference parameter for a plurality of macroblocks of a future frame according to the retrieved data, and updates data of the buffer with the generated reference parameters.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a block diagram of a video encoding apparatus according to an embodiment of the invention;

FIG. 2A is a timing diagram of frame processing of the video encoding apparatus according to an embodiment of the invention;

FIG. 2B is a timing diagram of frame processing of the video encoding apparatus according to an embodiment of the invention;

FIG. 2C is a timing diagram of frame processing of the video encoding apparatus according to an embodiment of the invention;

FIGS. 3A, 3B, and 3C are schematic diagrams of buffer snapshots at different time instants for describing data access to and from a buffer by the first operation and the second operation of FIG. 2A;

FIGS. 4A, 4B, and 4C are schematic diagrams of buffer snapshots at different time instants for describing data access to and from a buffer by the first operation and the second operation of FIG. 2B;

FIGS. 5A, 5B, and 5C are schematic diagrams of buffer snapshots at different time instants for describing data access to and from a buffer by the first operation and the second operation of FIG. 2C; and

FIG. 6 is a flowchart of a method for synchronizing data between a first operation and a second operation according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

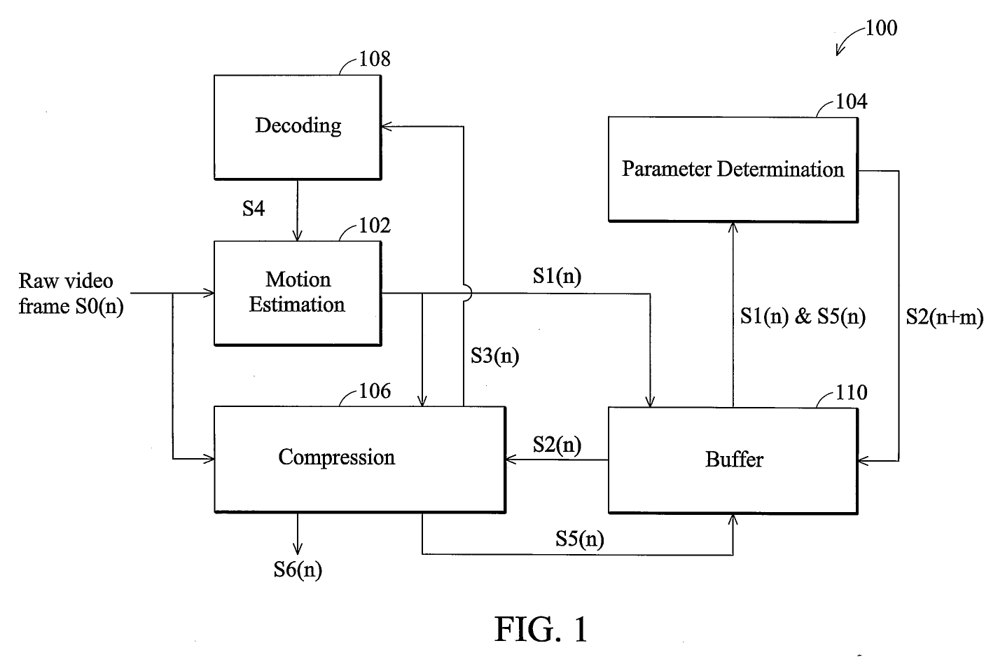

Referring to FIG. 1, a block diagram of a video encoding apparatus 100 according to an embodiment of the invention is shown. The video encoding apparatus 100 comprises a motion estimation module 102, a parameter determination module 104, a compression module 106, a decoding module 108, and a buffer 110. The motion estimation module 102 performs motion estimation on macroblocks of a raw video frame S0(n) to obtain motion estimation data S1(n) of a current frame, wherein n indicates a current frame index. The buffer 110 then stores the motion estimation data S1(n) macroblock by macroblcok. In an embodiment, the motion estimation data for each macroblock is generated with reference to a reconstructed frame S4, also called a reference frame. Motion estimation is used to eliminate the large amount of temporal redundancy that exists in video sequences. Motion estimation may choose different block sizes, and may vary the size of the blocks within a given frame, where the chosen block size may be equal or less than the macroblock size. Each block is compared to a block in the reference frame using some error measure, and the best matching block is selected. The search is conducted over a predetermined search area. To evaluate the estimation of matches between prediction macroblocks in the reference frame and macroblocks being encoded in the current frame, various matching criteria, such as CCF (cross correlation function), PDC (pel difference classification, MAD (mean absolute difference), MSD (mean squared difference), IP (integral projection) and the like may be employed. A motion vector denoting the displacement of the block in the reference picture with respect to the block in the current frame, is determined. The motion estimation module 102 further subtracts the matched block of the reference frame S4 from the current block of the current frame S0(n). The difference is then called residual data and typically contains less energy (or information) than the original block. The motion estimation module 102 may further calculates activity (also called complexity) and average luminance for each macroblock of the current frame S0(n).

The parameter determination module 104 retrieves the motion estimation data S1(n) and actual bit consumption S5(n) of macroblocks of the current frame from the buffer 110. The parameter determination module 104 then performs mode decision, quantization parameter (Qp) estimation, rate control and the similar according to at least one of the motion estimation data S1(n) and actual consumption of bits S5(n), and then determines parameters S2(n+m) such as a quantization parameter (Qp) value, an encoding mode and the like, for compressing each macroblock of a future raw frame S0(n+m), where m is a natural number. The parameter determination module 104 may determine whether a corresponding macroblock of the future frame is encoded as the intra mode or as the inter mode according to certain decision rules considering the described residual data, activity and average luminance with predefined thresholds. The parameter determination module 104 may utilize a constant bit rate (CBR) for a series of frames regardless of the complexity of each video interval to determine a Qp value. Bit rate is used to determine the video quality and define how much physical space that the video sequence of one second in bits. CBR technique assumes equal weighting of bit distribution among the series of frames which results in reducing the degree of freedom of the encoding task. The CBR encoding outputs a bitstream with an output rate kept at almost the same rate regardless of the content of the input video. As a result, for a video interval with simple content, the encoding quality will be good; however, for a video interval with complex content, the encoding quality will be poor. In CBR, the parameter determination module 104 may determine a bit budget for each macroblock of the further frame according to a frame bit budget regardless of complexity S1(n) of the current frame and actual consumption of bits S5(n) after compressing former macroblocks of the current frame. Subsequently, a Qp value is determined to achieve the determined bit budget. The parameter determination module 104 may employ a variable birate (VBR) for a series of frames with consideration of the complexity of each video interval to determine a Qp value. VBR technique produces non-constant output bit-rate during a period of time, and a complex frame consumes a higher bit rate than that of a plain frame. CBR control or VBR control embedded in the the parameter determination module 104 is utilized to control quantization values (e.g. quantization step size) to enable the output bit rate or bit rates to meet the requirement. In VBR, the parameter determination module 104 may determine a bit budget for each macroblock of the future frame according to a frame bit budget with considerations of complexity S1(n) of the current frame and actual consumption of bits S5(n) after compressing the prior macroblocks of the current frame. Subsequently, a Qp value is determined to achieve the determined bit budget. The parameter determination module 104 then stores the determined parameters S2(n+m) for each macroblock of the future frame in the buffer 110 as reference parameters for processing the future frame.

The compression module 106 retrieves a mode decision S2(n) for each macroblock of the current frame from the buffer 110. It is to be understood that the mode decision stored in the buffer 110 is determined by the parameter determination module 104 based at least on the motion estimation data S1(n−m) and actual consumption of bits S5(n−m) of a previous frame. When a macroblock of the current frame is determined to be encoded as the inter mode by the parameter determination module 104, the compression module 106 then sequentially performs discrete cosine transformation (DCT), quantization and variable length encoding (VLE) on the residual data of the macroblock of the raw frame S0(n) according to the reference parameters S2(n) to generate an output bitstream of the current frame S6(n). When a macroblock is determined to be encoded as the intra mode by the parameter determination module 104, the compression module 106 then sequentially performs DCT, quantization and VLE on the raw data of the macroblock of the raw frame S0 according to the reference parameter S2(n) to generate an output bitstream S6(n). In DCT, pixel data (raw data or residual data) of each macroblock of the current frame is transformed into a set of frequencies (also called DCT coefficients) by a forward discrete cosine transform (FDCT) formula. In quantization, the compression module 106 retrieves a determined Qp value S2(n) of each macroblock from the buffer 110 and may calculate a luminance base table and a chrominance base table based on the determined Qp value and quantize the transformed DCT coefficients of each macroblock with reference to the calculated luminance or chrominance base table. It is to be understood that the Qp value stored in the buffer 110 is determined by the parameter determination module 104 based at least on the motion estimation data S1(n−m) and actual consumption of bits S5(n−m) of a previous frame. In VLE, all quantized DCT coefficients of macroblocks may be sequentially encoded by a zero run-length encoding (RLE) method to generate a RLE code stream and the generated RLE code stream may be encoded by an entropy encoding method (e.g. Huffman encoding) to generate a variable length coding (VLC) bitstream as the output S6(n). In addition, the compression module 106 also generates an actual bit consumption S5(n) of compressed macroblocks of the current frame. The actual bit consumption S5(n) is then delivered to and stored in the buffer 110 and the stored actual bit consumption for each macroblock is utilized to determine reference parameters for a future frame.

In addition, the quantized DCT coefficients of macroblocks of the current frame S3(n) are also transmitted to the decoding module 108. When a macroblock is determined to be encoded in the inter mode, the decoding module 108 then sequentially performs inverse-quantization (IQ), inverse discrete cosine transformation (IDCT) and block replacement on the de-quantized DCT coefficients of macroblocks S3(n) according to the reference parameter S2(n) to reconstruct a frame S4 for future reference. When a macroblock is determined to be encoded in the intra mode, the decoding module 108 then sequentially performs IQ and IDCT on the quantized DCT coefficients of macroblocks S3(n) according to the reference parameter S2(n) to reconstruct a frame S4 for future reference. In IQ, the decoding module 108 may calculate a luminance base table and a chrominance base table based on the determined Qp value and de-quantize the quantized DCT coefficients of macroblocks of the current frame with reference to the calculated luminance and chrominance base tables to generate de-quantized DCT coefficients. In IDCT, the decoding module 108 may transform each de-quantized DCT coefficient of macroblocks of the current frame into decoded pixel data by an inverse discrete cosine transform (IDCT) formula. In block replacement, the decoding module 108 may add matched macroblocks of a reference frame S4(n−1) to predicted macroblocks of the current frame S0(n) according to the determined motion vector.

In some embodiments, mode decision is performed in the motion estimation module 102 while the parameter determination module 104 performs Qp value determination.

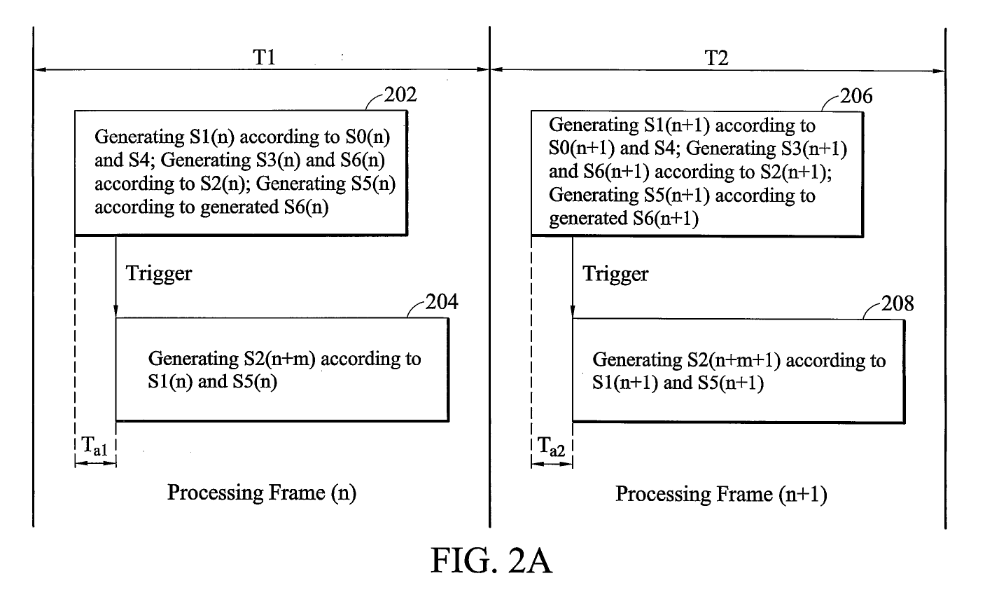

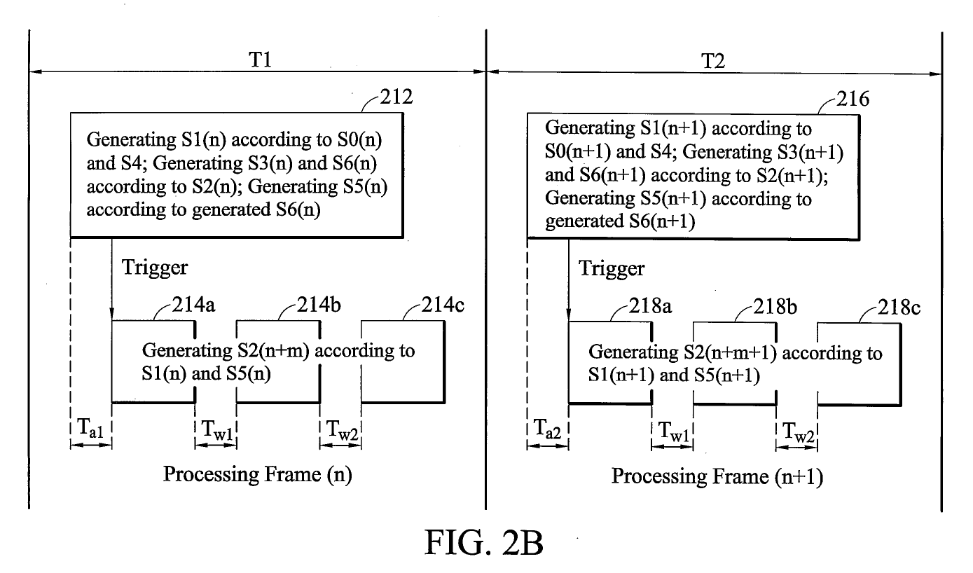

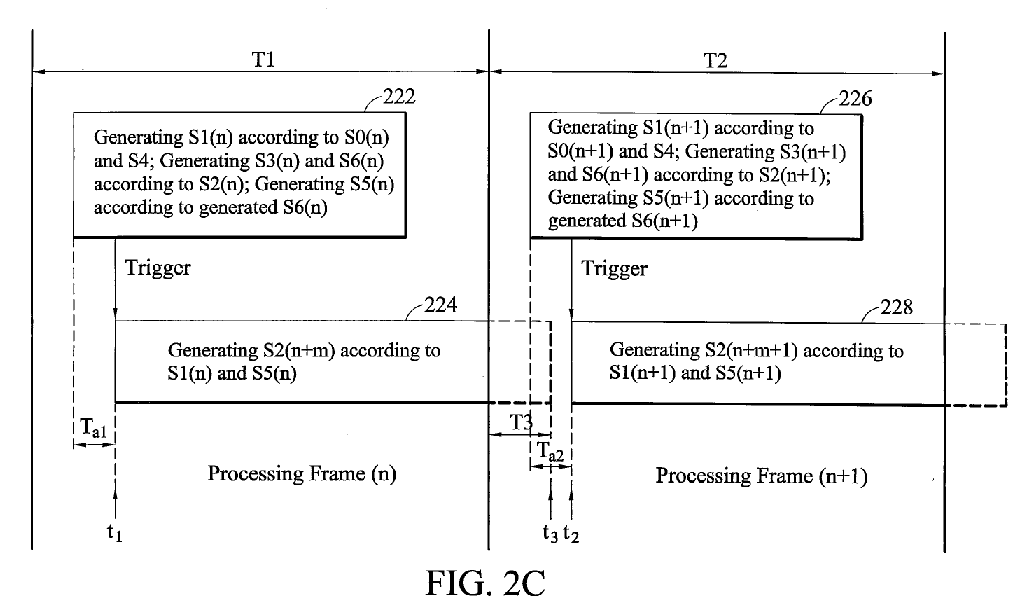

The video encoding apparatus 100 may process each raw frame within a budget threshold. In an embodiment, the video encoding apparatus 100 processes 30 raw frames per second, and a time budget for processing each frame is 33 ms. Referring to FIG. 2A, a timing diagram of frame processing of the video encoding apparatus 100 according to an embodiment of the invention is shown. The entire video encoding process is divided into two operations 202 and 204. As shown in FIG. 2A, the first operation 202 and the second operation 204 consumes substantially equal data processing time for a frame. During the first operation 202, motion estimation data S1(n) of each macroblock of the current frame is generated for current and future reference according at least to the current frame S0(n) and a reconstructed frame S4, output bitstream S6(n) and quantized DCT coefficients S3(n) are generated according at least to the reference parameters S2(n) from the buffer 110, as well as, the actual bit consumption S5(n) after encoding the current macroblock of the current frame is generated for future reference, wherein n is a frame index of the current frame and m is an integer greater than or equal to one. During the second operation 204, reference parameters S2(n+m) for each macroblock of a future frame are generated according at least to the motion estimation data of the corresponding macroblock of a current frame S1(n) and actual bit consumption S5(n) after encoding the prior macroblocks of the same frame. The video encoding apparatus 100 therefore must also complete both operations 202 and 204 within a time period of 33 ms. Because encoding for each macroblock of the current frame refers to previously buffered reference parameters S2(n) and the reference parameters are prepared in advance according at least to the motion estimation data S1(n−m) of the corresponding macroblock of a previous frame and actual bit consumption S5(n−m) after encoding the prior macroblocks of the same frame instead of that of the current frame, certain data dependencies are broken and a portion of the operations 202 and 204 can be simultaneously performed.

Generation of the reference parameters S2(n+m) of the future frame in second operation 204 requires motion estimation data S1(n) and actual bit consumption S5(n) which are determined after motion estimation and actual encoding to the current frame in first operation 202. The second operation 204 is therefore performed after the first operation 202 has generated and stored requisite motion estimation data S1(n) and actual bit consumption S5(n) in the buffer 110. The video encoding apparatus 100 therefore triggers the second operation 204 subsequent to the start of the first operation 202 for a predetermined waiting period. For example, after a waiting period Tₐ₁ started from initiation of the first operation 202 has passed, the motion estimation module 102 generates and stores the motion estimation data S1(n) of the corresponding macroblocks of the current frame in the buffer 110, as well as, the compression module 106 generates the quantized DCT coefficients S3(n) and the output bitstream S6(n) corresponding to the certain macroblocks of the current frame according to the reference parameters S2(n) of the buffer 110 and stores actual bit consumption S5(n) of the corresponding macroblocks of the current frame according to the output datastream S6(n) in the buffer 110. A timer may be utilized to count or countdown the waiting period Tₐ₁, the second operation 202 is activated when receiving a signal indicating that the waiting period Tₐ₁ has elapsed from the timer. In another embodiment, the video encoding apparatus 100 may trigger the second operation 204 after a certain number of beginning macroblocks of current frame are completely reconstructed and encoded in the first operation 202. In the second operation 204, the parameter determination module 104 generates reference parameters S2(n+m) for each macroblock of the future frame according to the buffered motion estimation data S1(n) and actual bit consumption S5(n) of a corresponding macroblock of the current frame and replaces the motion estimation data S1(n) and actual bit consumption S5(n) of the buffer 110 with the generated reference parameters S2(n+m). Duration of the first operation 202 and the second operation 204 may overlap except for the waiting period Tₐ₁. Both the first operation 202 and the second operation 204 for the current frame must be completed during the budgeted period T1 of 30 ms.

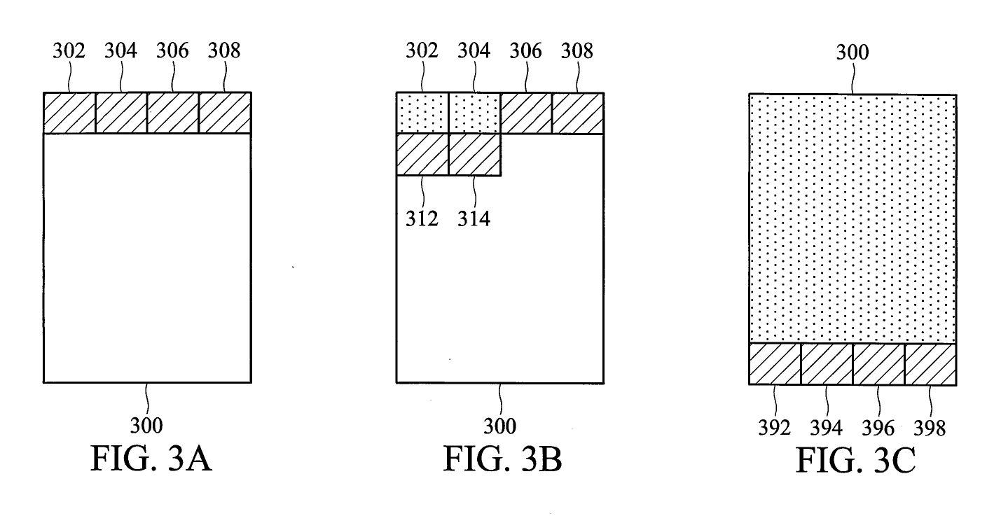

Referring to FIGS. 3A, 3B, and 3C, schematic diagrams of buffer snapshots at different time instants are shown for describing data access to and from the buffer 110 by the first operation 202 and the second operation 204 of FIG. 2A. Assume that the buffer 110 comprises a memory space 300 comprising a plurality of blocks, each for storing reference parameters S2(n) of a macroblock of a current frame with a frame index n. It is to be understood that the stored reference parameters S2(n) is determined by the parameter determination module 104 based at least on the motion estimation data S1(n−1) and actual consumption of bits S5(n−1) of a previous frame. When the video encoding apparatus 100 starts to process a current raw frame with a frame index n, the first operation 202 is triggered. After the compression module 106 retrieves the reference parameters S2(n) corresponding to macroblocks of the previous frame from the memory space 300 of the buffer 110, the retrieved blocks of the memory space 300 shaded with slant lines in FIGS. 3A˜3C are replaced with motion estimation data S1(n) and actual consumption of bits S5(n) of the current frame generated by the motion estimation module 102 and the compression module 106 respectively. In FIG. 3A, after four blocks 302˜308 of the memory space 300 are accessed by the first operation 202, the second operation 204 is triggered. The parameter determination module 104 starts to generate reference parameters S2(n+1) of macroblocks of a future raw frame S0(n+1) according to buffered data S2(n) and S5(n), and the newly generated reference parameters S2(n+1) are then stored back to the blocks of the memory space 300 of the buffer 110. In FIG. 3B, the first operation 202 further retrieves reference parameters S2(n) from the next two blocks 312 and 314 of the buffer 110 and stores motion estimation data S1(n) and actual consumption of bits S5(n) in the blocks 312 and 314 in parallel of that new reference parameters S2(n+1) generated in the second operation 204 are stored in the blocks 302 and 304, which are shaded with dots. In FIG. 3C, when the first operation 202 is completed, the reference parameters S2(n) corresponding to all macroblocks of the current frame are retrieved for encoding the current raw frame S0(n), but the second operation 204 still has to generate reference parameters S2(n+1) corresponding to the last four macroblocks of the future frame and store in blocks 392˜398 of the buffer 110.

Referring to FIG. 2B, a timing diagram of frame processing of the video encoding apparatus 100 according to an embodiment of the invention is shown. The first operation 212 consumes much data processing time for a frame than that of the second operation 214. After a waiting period Tₐ₁ has passed, the first operation 212 generates and stores the motion estimation data S1(n) of the corresponding macroblocks of the current frame in the buffer 110, as well as, generates the quantized DCT coefficients S3(n) and the output bitstream S6(n) corresponding to certain macroblocks of a current raw frame S0(n) and stores actual bit consumption S5(n) of the corresponding macroblocks of the current frame according to the output datastream S6(n) in the buffer 110. The second operation 214 is further triggered after the waiting period Tₐ₁ has passed. When the second operation 214 has a data processing speed faster than that of the first operation 212, the second operation 214 consumes shorter time to process a macroblock of the current frame to prepare and store reference parameters S2(n+1) for a corresponding macroblcok of a future frame than that to compress and reconstruct a macroblock of the current frame by the first operation 212. After completely processing a certain number of macroblocks of the current frame, the second operation 214 halts for a short waiting period to avoid to damage reference parameters S2(n) for a macroblock of the current frame, which have not been retrieved by the first operation 212, such as the waiting periods T_{w1} and T_{w2} shown in FIG. 2B. A timer set in the second operation 202 may be utilized to count or countdown the waiting period T_{w1} or T_{w2}, the second operation 202 is re-activated when receiving a signal indicating that the waiting period T_{w1} or T_{w2} has elapsed from the timer. After the short waiting period has elapsed, the second operation 214 starts to process the remaining macroblocks of the current frame. In another embodiment, after completely processing each macroblock of the current frame, the second operation 214 inspects the process progress by the first operation 212, which may be indicated by a flag storing an index of the last macroblock has been successfully processed by the first operation 212, and halts for a short waiting period if an index of a macroblock to be processed by the second operation 214 equals that in the flag or the difference between an index of a macroblock to be processed by the second operation 214 and that in the flag is less than a predefined value (e.g. two or more).

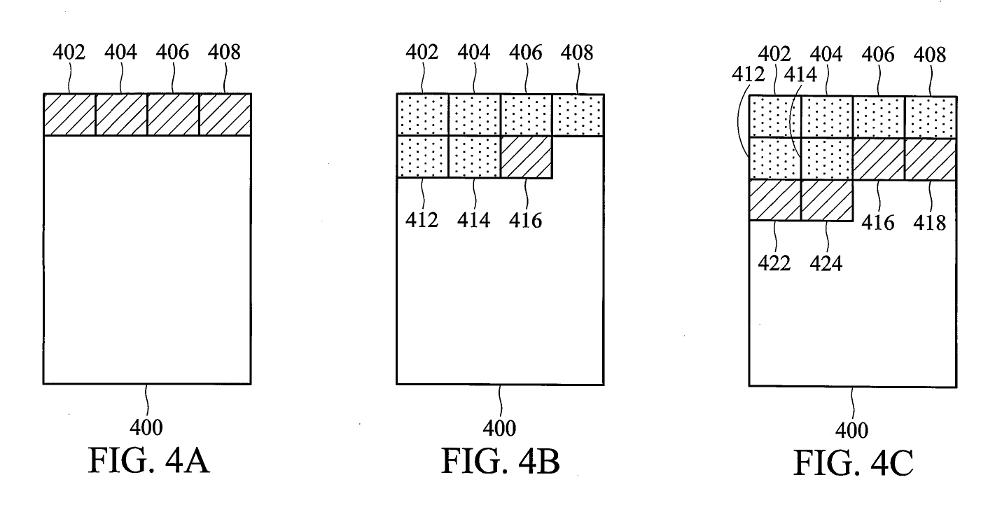

Referring to FIGS. 4A, 4B, and 4C, schematic diagrams of buffer snapshots at different time instants are shown for describing data access to and from the buffer 110 by the first operation 212 and the second operation 214 of FIG. 2B. Assume that the buffer 110 comprises a memory space 400 comprising a plurality of blocks, each for storing reference parameters S2(n) of a macroblock of a current frame with a frame index n. It is to be understood that the stored reference parameters S2(n) is determined by the parameter determination module 104 based at least on the motion estimation data S1(n−1) and actual consumption of bits S5(n−1) of a previous frame. The blocks storing reference parameters S2(n) have been retrieved by the first operation 212 and subsequently been replaced with motion estimation data S1(n) and actual consumption of bits S5(n) of the current frame by the first operation 212 are shaded with slant lines, and the blocks storing reference parameters S2(n+1) generated by the second operation 214 are shaded with dots. In FIG. 4A, after the first operation 212 accesses reference parameters S2(n) from the blocks 402˜408 and stores motion estimation data S1(n) and actual consumption of bits S5(n) in the blocks 402˜408, the second operation 214 is triggered. At a time instant, referring to FIG. 4B, the first operation 212 accesses three blocks 412˜416 and the second operation 214 with a faster data processing speed, however, has processed data of six macroblocks to generate and store reference parameters S2(n+1) in the blocks 402˜414. Then, the second operation 214 halts for waiting period T_{w1} to avoid replacement of reference parameters S2(n) of the block 416, which has not been retrieved by the first operation 212. Referring to FIG. 4C, at a time instant after the waiting period T_{w1} has passed, the first operation 212 generates and stores additional S1(n) and S5(n) corresponding to subsequent macroblocks in blocks 416˜424. Therefore, the second operation 214 can then start to generate subsequent reference parameters S2(n+1) corresponding to the subsequent macroblocks of the future frame and store the newly generated data S2(n+1) in the blocks 416˜424. In addition, both the first operation 212 and the second operation 214 are completed during the budgeted period T1 of 30 ms.

Referring to FIG. 2C, a timing diagram of frame processing of the video encoding apparatus 100 according to an embodiment of the invention is shown. The second operation 224 may consume longer time to process a macroblock of a current frame to prepare and store reference parameters S1(n+1) of a future frame than that to compress and reconstruct a macroblock of the current frame by the first operation 222. The first operation 222 completes data processing corresponding to all macroblocks of a current frame during the budgeted period T1 of 30 ms. The second operation 224, however, does not complete generation of the reference parameters S2(n+1) of a few end macroblocks of the future frame at the end of the budgeted period T1. After the first operation 226 corresponding to a next frame is started, the second operation 224 can still continue its processing of the end macroblocks for the future frame during an extra extension period T3, but extended data processing of the second operation 224 corresponding to the future frame must be completed at a time t3 prior to a starting time t2 of another second operation 228 for the next frame.

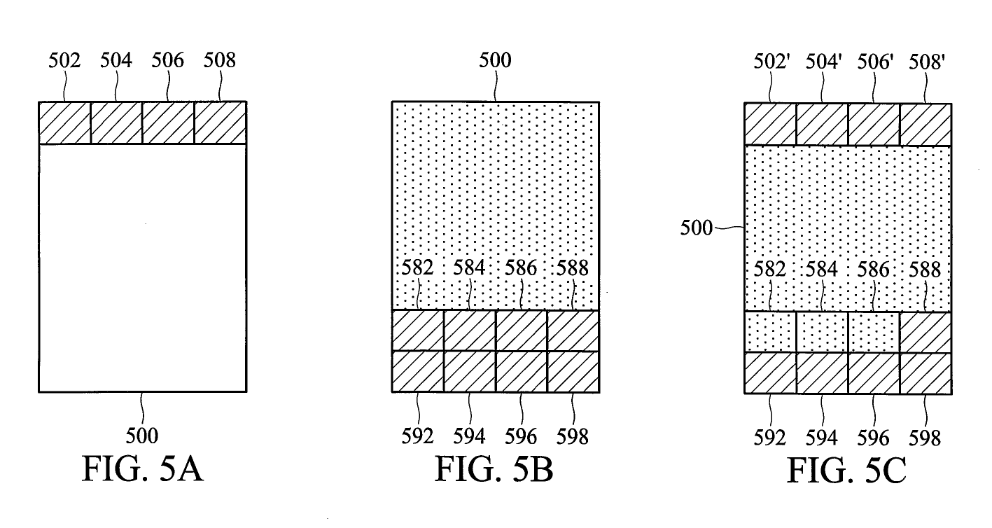

Referring to FIGS. 5A, 5B, and 5C, schematic diagrams of buffer snapshots at different time instants are shown for describing data access to and from the buffer 110 by the first operation 222 and the second operation 224 of FIG. 2C. Assume that the buffer 110 comprises a memory space 500 comprising a plurality of blocks, each for storing reference parameters S2(n) of a macroblock of a current frame with a frame index n. It is to be understood that the stored reference parameters S2(n) is determined by the parameter determination module 104 based at least on the motion estimation data S1(n−1) and actual consumption of bits S5(n−1) of a previous frame. The blocks storing reference parameters S2(n) have been retrieved by the first operation 222 and subsequently been replaced with motion estimation data S1(n) and actual consumption of bits S5(n) of the current frame by the first operation 222 are shaded with slant lines, and the blocks storing reference parameters S2(n+1) generated by the second operation 224 are shaded with dots. In FIG. 5A, after the first operation 222 accesses reference parameters S2(n) from the blocks 502˜508, the second operation 224 is triggered. In FIG. 5B, when the data processing speed of the second operation 224 is lower than that of the first operation 222, when a budgeted period T1 for processing the current frame has passed, the first operation 222 completes data processing corresponding to all macroblocks of the current frame, but the second operation 224 still has to generate and store reference parameters S2(n+1) corresponding to a few end macroblocks of the future frame in eight blocks 582˜598. In FIG. 5C, another first operation 226 for a next frame is started. After the first operation 226 has retrieved reference parameters S2(n+1) from the blocks 502′˜508′ and generates and stores motion estimation data S1(n+1) and actual consumption of bits S5(n+1) in the blocks 502′˜508′, another second operation 228 for another future frame (n+2) is to be triggered, and the second operation 224 for the future frame (n+1) have to be stopped. Because the second operation 224 has not fully generated reference parameters S2(n+1) corresponding to the five end macroblocks of the future frame (n+1), the parameter determination module 104 notifies the compression module 106 of encoding the five end macroblocks of the future frame (n+1) using the same default values and further notifies the decoding module 108 of reconstructing the five end macroblocks of the future frame (n+1) using predetermined default values of reference parameters.

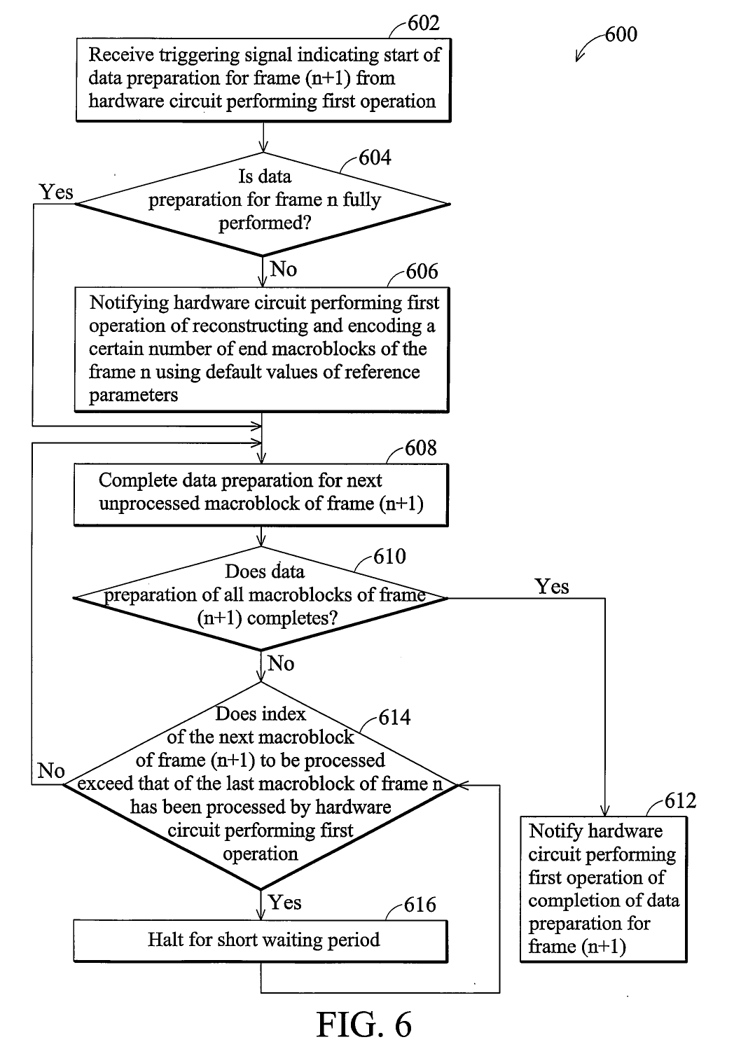

Referring to FIG. 6, a flowchart of a method 600 for synchronizing data processing between a first operation and a second operation according to an embodiment of the invention is shown. The method 600 is performed during the described second operation. Assume the first operation generates quantized DCT coefficients S3(n) and output data stream S6(n) corresponding to a certain number of macroblocks of a current frame according to the buffered reference parameters S2(n). Execution sequence between the first operation and the second operation may refer together to FIGS. 2A, 2B, and 2C.

In step 602, after generation of quantized DCT coefficients S3(n) and output data stream S6(n) corresponding to a certain number of macroblocks of a current frame n, a triggering signal indicating start of data preparation for a future frame (n+1) is received from hardware circuit performing the first operation, such as a combination of the decoding module 103, the motion estimation module 102 and the compression module 106. In step 604, it is first determined whether data preparation for the current frame n is fully performed. If so, the process directly proceeds to step 608 to start to prepare reference parameters S2(n+1) for the future frame. Otherwise, the process proceeds to step 606 to notify the hardware circuit performing first operation of reconstructing and encoding a certain number of end macroblocks of the frame n using default values of reference parameters and subsequently to step 608. In step 608, data preparation for an unprocessed macroblock of the frame (n+1) completes, where details of data preparation may refer to the above descriptions and are not described herein for brevity. After that, it is determined whether data preparation of all macroblocks of the frame (n+1) completes in step 610 and whether an index of the next macroblock of the frame (n+1) to be processed exceeds that of the last macroblock of the frame n has been processed by the hardware circuit performing the first operation in step 614. When data preparation of all macroblocks of the frame (n+1) completes the process proceeds to step 612 to notify the hardware circuit performing the first operation of completion of data preparation for frame (n+1). When data preparation of all macroblocks of the frame (n+1) does not complete and an index of the next macroblock of the frame (n+1) to be processed exceeds that of the last macroblock of the frame n has been processed by the hardware circuit performing the first operation the process proceeds to step 616 to halt for a short waiting period, such as T_{w1} or T_{w2} of FIG. 2B to avoid damage of non-retrieved reference parameters S2(n). After the short waiting period has elapsed, the process proceeds to step 614 to do the same inspection again. Otherwise, the process proceeds to step 608 to continue to deal with the next macroblock.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for video encoding with decoupled data dependency, comprising:
acquiring at least one reference parameter for a macroblock of a current frame from a buffer, wherein the reference parameter is determined according to data of a corresponding macroblock of a previous frame; and
encoding the macroblock of the current frame according at least to the determined reference parameter to generate an output bitstream.

2. The method as claimed in claim 1, wherein the index of current frame is n, the index of previous frame is n−m, and m represents an integer being greater than or equal to 1.

3. The method as claimed in claim 1, wherein the reference parameter comprises a bit budget determined according at least to actual consumption of bits after compressing the prior macroblocks of the previous frame.

4. The method as claimed in claim 3, wherein the reference parameter comprises a quantization value determined according at least to the bit budget and the encoding step further:
calculates a luminance base table and a chrominance base table based on the quantization value and quantizes a plurality of discrete cosine transform (DCT) coefficients of the macroblock of the current frame.

5. The method as claimed in claim 1, wherein the reference parameter indicates a determination of an intra mode or an inter mode according to motion estimation results of the macroblock of the previous frame and the encoding step further:
performs discrete cosine transform (DCT), quantization and variable length encoding (VLC) on the macroblock of the current frame when the reference parameter indicates a determination of the intra mode; and
performs motion compensation, DCT, quantization and VLE on the macroblock of the current frame when the reference parameter indicates a determination of the inter mode.

6. The method as claimed in claim 1, wherein generated data during performing motion estimation on the current frame and encoding the macroblock of the current frame is stored in the buffer.

7. The method as claimed in claim 6, wherein the generated data comprises at least one of the actual bit consumption for encoding the macroblock of the current frame, residual data, activity and average luminance of the macroblock of the current frame.

8. The method as claimed in claim 7, further comprising:
generating at least one reference parameter for a macroblock of a future frame according to the generated data in parallel of encoding the macroblock of the current frame; and
storing the generated reference parameter in the buffer for reference by the macroblock of the future frame.

9. An apparatus for video encoding with decoupled data dependency, comprising:
a buffer comprising at least one block;
a hardware circuit, coupled to the buffer, for generating and storing data during motion estimation for a current frame and encoding of the macroblock of the current frame in the block; and
a parameter determination module, coupled to the hardware circuit and the buffer, for retrieving the stored data from the block, generating at least one reference parameter for a corresponding macroblock of a future frame according to the retrieved data, and updating data of the block with the generated reference parameter.

10. The apparatus as claimed in claim 9, wherein the hardware circuit retrieves the reference parameter for the macroblock of the current frame from the block and encodes the current frame according at least to the retrieved reference parameter to generate an output bitstream.

11. An apparatus for video encoding with decoupled data dependency, comprising:
a buffer;
a hardware circuit, coupled to the buffer, for generating and storing data during performing motion estimation on a current frame and encoding a plurality of macroblocks of the current frame in the buffer; and
a parameter determination module, coupled to the hardware circuit and the buffer, for retrieving the stored data from the buffer, generating at least one reference parameter for a plurality of macroblocks of a future frame according to the retrieved data, and updating data of the buffer with the generated reference parameters after receiving a triggering signal indicating start of data preparation for the future frame from the hardware circuit.

12. The apparatus as claimed in claim 11, wherein the triggering signal is issued after the hardware circuit completely reconstructs and encodes a certain number of beginning macrobocks of the current frame.

13. The apparatus as claimed in claim 11, wherein the triggering signal is issued after a waiting period from a start of processing the current frame by the hardware circuit has elapsed.

14. The apparatus as claimed in claim 11, wherein the parameter determination module determines whether data preparation for all macroblocks of the current frame is fully performed, and when data preparation for all macroblocks of the current frame is not fully performed the parameter determination module notifies the hardware circuit of reconstructing and encoding a certain number of end macroblocks of the current frame using default values of references parameters.

15. The apparatus as claimed in claim 11, wherein after completing data preparation for each macroblock of the future frame the parameter determination module determines whether an index of the next macroblock to be processed exceeds an index of the last macroblock of the current frame has been processed by the hardware circuit, and when the index of the next macroblock to be processed exceeds the index of the last macroblock of the current frame has been processed by the hardware circuit the parameter determination module halts for a waiting period.

16. The apparatus as claimed in claim 15, wherein the waiting period is counted by a timer, and the parameter determination continues to generate reference parameters for the remaining macroblocks of the future frame after receiving a signal indicating that the waiting period has elapsed from the timer.

17. The apparatus as claimed in claim 11, wherein after completing data preparation for a certain number of macroblocks of the future frame the parameter determination module halts for a waiting period.

18. The apparatus as claimed in claim 17, wherein the waiting period is counted by a timer, and the parameter determination continues to generate reference parameters for the remaining macroblocks of the future frame after receiving a signal indicating that the waiting period has elapsed from the timer.

19. The apparatus as claimed in claim 11, wherein after generating reference parameters for all macroblocks of the future frame the parameter determination module notifies the hardware circuit of completion of data preparation for the future frame.

20. The apparatus as claimed in claim 11, wherein the reference parameters comprises at least one of a bit budget and a quantization value, the bit budget is determined according at least to actual consumption of bits after compressing the prior macroblocks of the current frame, and the quantization value is determined according at least to the bit budget.
